(19) United States
(12) Patent Application Publication
(10) Pub. No.: US 2026/0078056 A1
(43) Pub. Date: Mar. 19, 2026

(54) FORMULATIONS AND METHODS FOR CONCRETE WITH BIOCHAR SUPPLEMENTARY CEMENTITIOUS MATERIAL

(71) Applicant: Solid Carbon, Inc., McMinnville, OR (US)

(72) Inventors: Johnathan Douglas Mead, McMinnville, OR (US); Sean William Muir, Corvallis, OR (US); Allan Mackenzie Whitaker, IV, Sheridan, OR (US)

(21) Appl. No.: 19/329,265

(22) Filed: Sep. 15, 2025

Related U.S. Application Data
(60) Provisional application No. 63/695,271, filed on Sep. 16, 2024.

(51) Int. Cl. C04B 26/02; C04B 18/02; C04B 18/08; C04B 111/00

(52) U.S. Cl. CPC C04B 26/02; C04B 18/022; C04B 18/08; C04B 2111/00112; C04B 2235/721

(57) ABSTRACT

Systems and method are provided for a biochar concrete. The biochar concrete includes a low carbon fraction biochar, non-biochar cementitious material, coarse aggregate, fine aggregate, and water. A mass of the low carbon fraction biochar, mass of the non-biochar cementitious material, mass of the coarse aggregate, mass of the fine aggregate, and mass of water depend on a binder fraction of the low carbon fraction biochar which is less than 70% carbon by mass.

### CROSS-REFERENCE TO RELATED APPLICATIONS

The present application claims priority to U.S. Provisional Application No. 63/695,271 entitled “FORMULATIONS AND METHODS FOR CONCRETE WITH BIOCHAR SUPPLEMENTARY CEMENTITIOUS MATERIAL” filed on Sep. 16, 2024. The entire contents of the above application is hereby incorporated by reference for all purposes.

### FIELD

The present description relates generally to formulations and methods for concrete including supplementary cementitious material formed of biochar.

### BACKGROUND AND SUMMARY

Concrete is responsible for 7% of global greenhouse emissions. Most of the legacy CO₂ emissions associated with concrete stem from the production of Ordinary Portland Cement (OPC). Clinker (the precursor of OPC) is created in high temperature kilns releasing CO₂ from the fossil fuels used for heat, and chemical CO₂ released from limestone. However, an overall carbon footprint of concrete may be reduced by sequestering carbon within the concrete itself.

Carbon may be sequestered in concrete in the form of biochar derived replacements for supplementary cementitious materials (SCM) and admixture. Conventionally, carbon may negatively impact physical properties of concrete systems when incorporated at more than a range of 5%-10% by mass, thereby limiting an amount of biochar that can be sequestered per volume of concrete.

The inventors have recognized the above-mentioned drawbacks in the previous strategies for incorporating low carbon fraction biochar in concrete as supplementary cementitious material. The above-mentioned drawbacks may be at least partially addressed by a biochar concrete, comprising: a low carbon fraction biochar, wherein the low carbon fraction biochar is less than 70% carbon by mass, non-biochar cementitious material, coarse aggregate, fine aggregate, and water, wherein a mass of the low carbon fraction biochar, a mass of the non-biochar cementitious material, a mass of the coarse aggregate, a mass of the fine aggregate, and a mass of the water depend on a binder fraction of the low carbon fraction biochar. By determining an amount of water and cementitious in this way more carbon may be sequestered by the concrete while still maintaining a desired strength of the resulting concrete.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a flowchart of an overview of a method for forming biochar concrete with low carbon fraction biochar.

FIG. 2 shows a flowchart of an example of a method for determining a binder fraction of a biochar as part of the method of FIG. 1.

FIG. 3A shows a scanning electron microscope (SEM) image of a first biochar and an SEM image of second biochar.

FIG. 3B shows an energy dispersive X-ray spectroscopy (EDS) compositional map of the SEM images of FIG. 3A.

FIG. 4 shows an X-ray diffraction (XRD) spectrum of the first biochar and an XRD spectrum of the second biochar.

FIG. 5 shows a graph determining a pozzolanic reactivity test (PRT) score of the first biochar and of the second biochar.

FIG. 6 shows a flowchart of an example of a method for determining a biochar concrete formulation including biochar as part of the method of FIG. 1.

FIG. 7 shows an example of biochar concrete formed by the method of FIG. 1.

### DETAILED DESCRIPTION

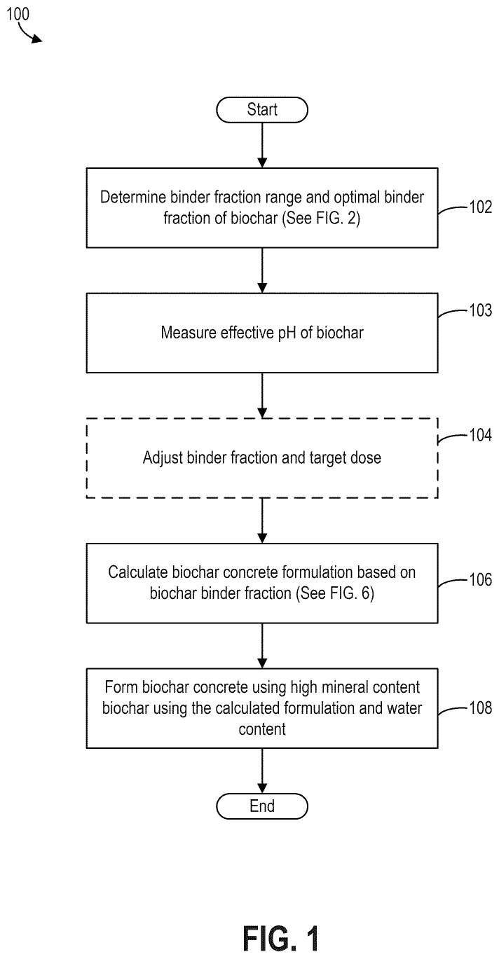

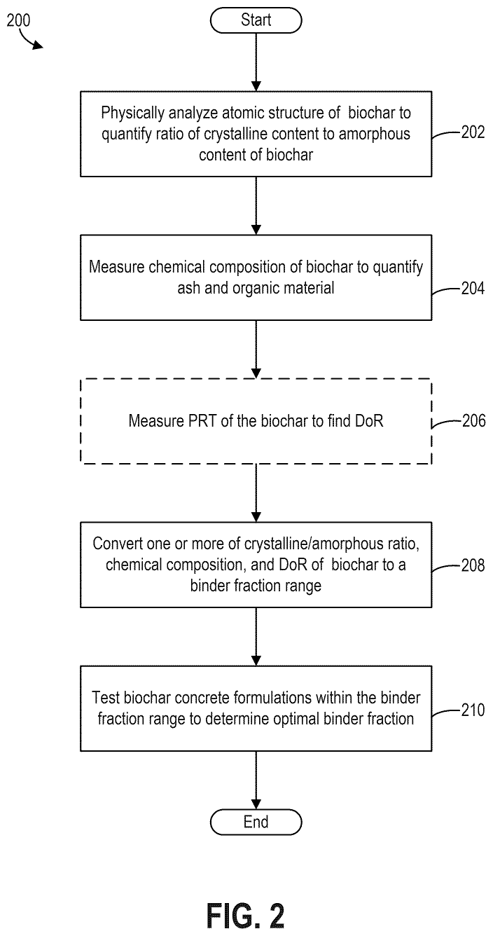

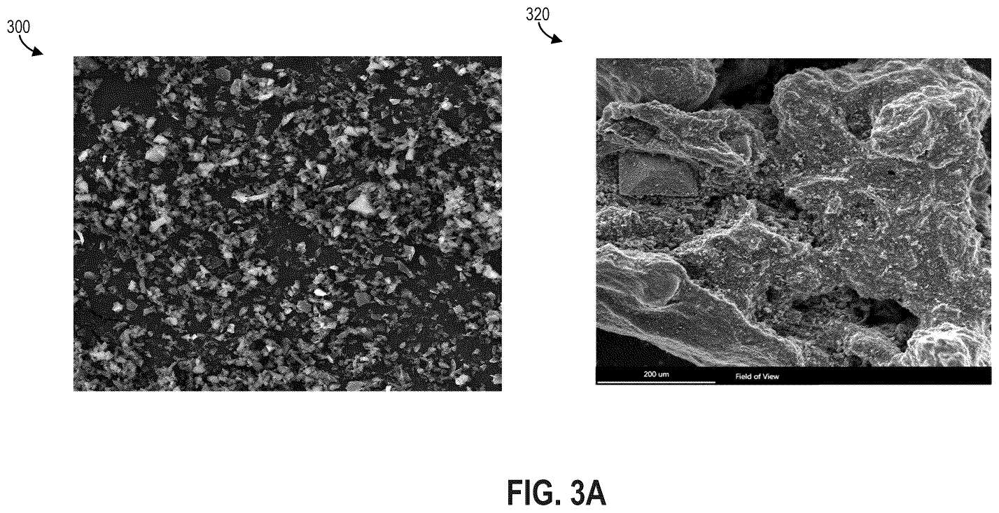

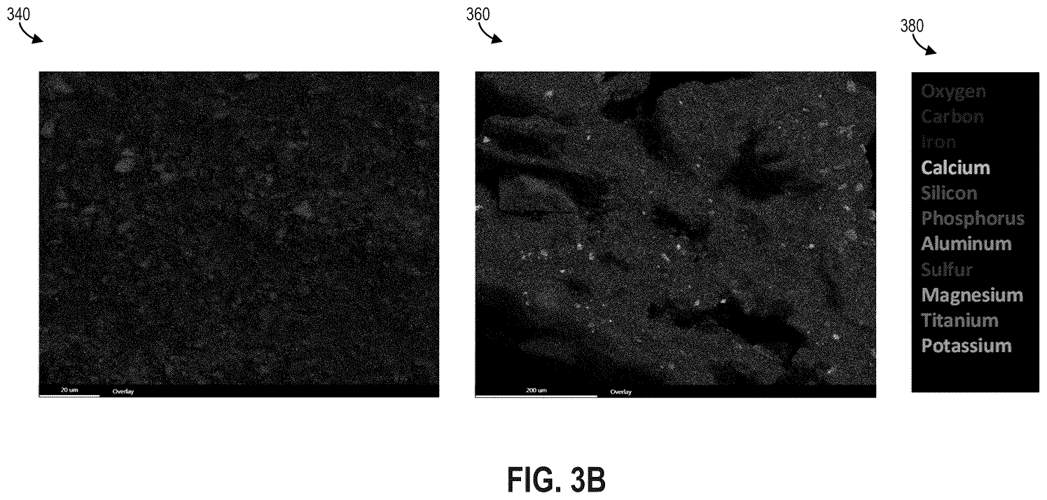

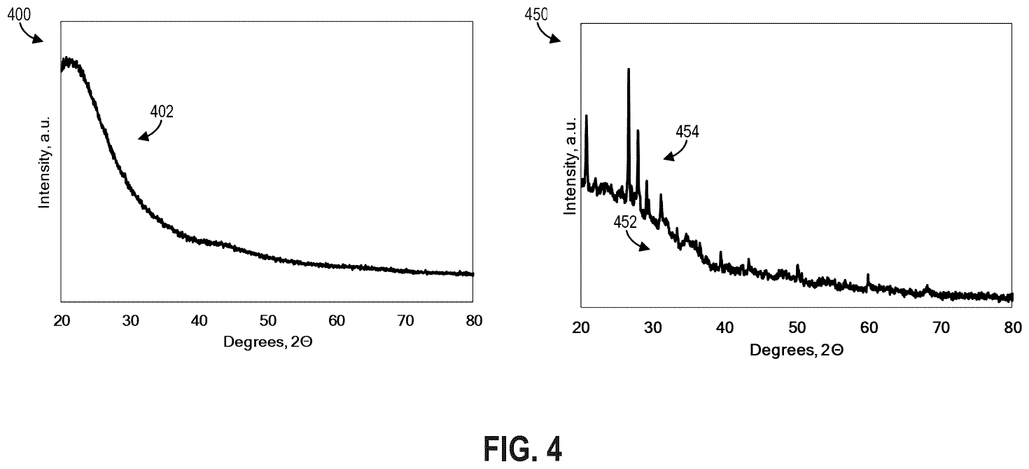

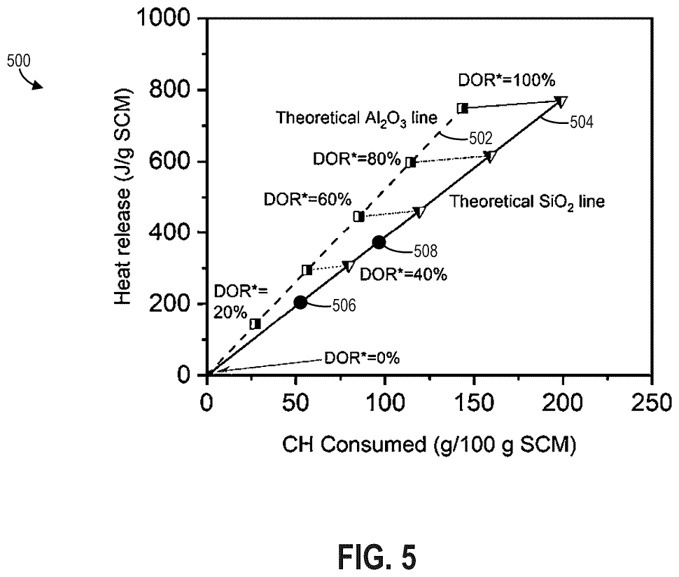

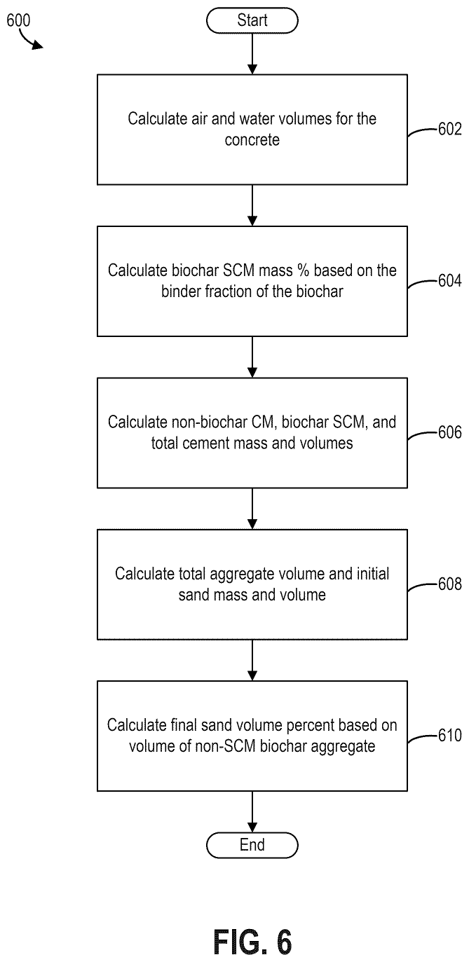

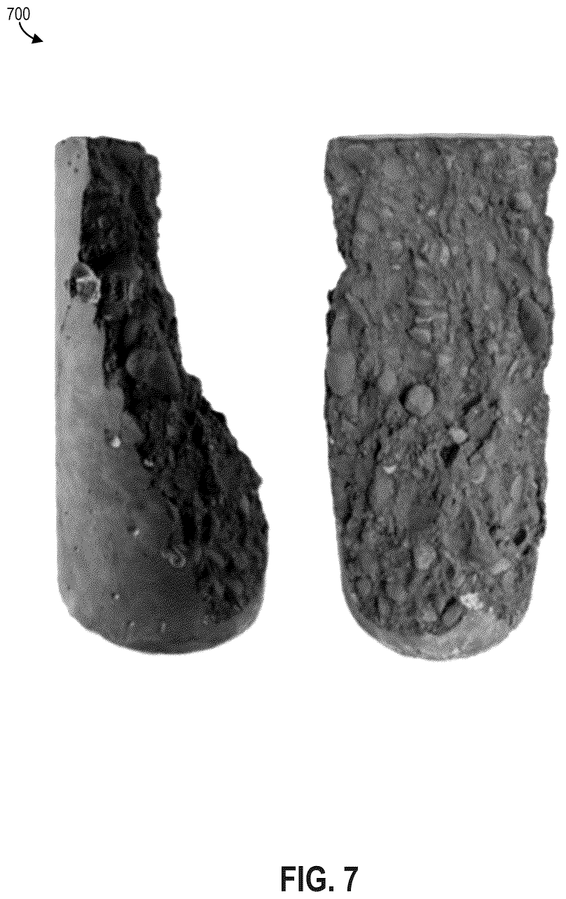

The following description relates to formulations and methods for concrete including biochar. Biochar may be obtained by pyrolyzing an organic waste such as agricultural wastes and municipal wastes, among others. The inventors herein recognize that a composition of a biochar may vary based on the source and may even vary between batches of a single source. A method is provided herein in FIG. 1 to determine a formulation for concrete including biochar having a low carbon fraction. Biochars having a low carbon fraction may also be referred to as high mineral content biochars. By recognizing that biochars include both material that acts as supplementary cementitious material (SCM) and non-SCM material, the SCM and non-SCM fractions may be quantified and the concrete formulation calculated accordingly. A method is provided to determine a binder fraction of a biochar. The binder fraction may herein refer to a quantitative value equivalent to a mass fraction of the biochar acting as SCM in a concrete formulation. An example of a method for determining the binder fraction is shown in FIG. 2. Determining the binder fraction may include determining physical characteristics via SEM and XRD as shown in FIGS. 3A and 4, chemical composition, as shown in FIG. 3B and chemical reactivity characteristics such as a pozzolanic reactivity in a pozzolanic reactivity test (PRT) based on the graphs shown in FIG. 5. Once the binder fraction of the biochar is determined, it may be used calculate a concrete formulation as shown in the example method of FIG. 6. An example of resulting biochar concrete is shown in FIG. 7. The concrete formulation determined using the calculated binder fraction instead of accounting for the biochar as all SCM or as all aggregate, may include a higher mass percent of biochar while still maintaining desired physical characteristics of the concrete.

Turning now to FIG. 1 an overview of a method 100 for forming biochar concrete is shown. Biochar may be formed by pyrolyzing (e.g., heating in a low-oxygen environment) a waste feedstock which includes carbon of organic origin. For example, the waste feedstock from which the biochar is manufactured may include one or more of wood based biomass, municipal waste biomass, agriculturally sourced biomass, aquatic plant sourced biomass, livestock generated biosolids, animal waste, food waste source biomass, and yard waste biomass, among others. In some examples, the biochar may be low carbon fraction biochar. Low carbon fraction biochars may include biochars including less than 70% carbon by mass. In alternate examples low carbon fraction biochars may include between 25% and 60% carbon by mass. Low carbon fraction biochar may also be considered high mineral fraction biochar. The biochar may be ground biochar. Ground biochar may be ground by one or more of vortex milling, hammer milling, roller milling, and disk milling.

At 102, method 100 includes determining a binder fraction range and optimal binder fraction of the biochar. Binder fraction may be defined by equation 1 below.

$$Binder Fraction = \frac{Amount of SCM in biochar ( kg )}{Total mass of biochar ( kg )} \qquad ( 1 )$$

A carbon fraction may be one of a plurality of biochar characteristics used to calculate the amount of SCM in the biochar and to calculate binder fraction range and optimal binder fraction as described further in the method of FIG. 2 below. Determining the amount of SCM in biochar may be further based on crystallinity of the biochar, thermodynamic properties, as well as chemical composition (e.g., carbon content).

At 103, method 100 includes measuring an effective pH of the biochar. As one example, measuring effective pH of the biochar may include soaking the biochar in water and then measuring a resulting pH of the water in which the biochar was soaked. In one example, the pH of the water may be adjusted to a high pH (e.g., >9) to replicate a pH of a conventional concrete system before mixing the water with the biochar. Soaking the biochar may include soaking for a duration of 24 hrs. In some examples the biochar and water mixture may be agitated and/or stirred before pH of the water is measured. The biochar and the water may be mixed in a mass ratio of 1:10. pH may be measured using litmus paper, a pH calibrated electrode, or the like.

Without being bound by theory, biochars having a higher effective pH may be more desirable than those having a lower effective pH. As one example, a desired effective pH may be greater than 7. Biochar having a high effective pH may increase a cement strength and reduce steel rebar corrosion. Further, biochar having a high effective pH may help avoid degrading alkali-silica reactions occurring between cementitious materials and high silica aggregates in highly alkaline concrete systems.

At 104, method 100 optionally includes adjusting the biochar based on the determined binder fraction to a target binder fraction. A target binder fraction may be a desired binder fraction which results in target amount of biochar being included in the biochar concrete formulation. Adjusting the binder fraction may include increasing the binder fraction by adding ash, other mineral sources, or other known SCM material to the biochar. For example, the biochar may further include one or more of biogenically sourced ash products, chemical admixtures, and combustion ash products. In some examples, ash products may be ground ash products. Ground ash products may be ground by one or more of vortex milling, hammer milling, roller milling, and disk milling. In some examples, the added known SCM material may be derived from waste streams. In alternate examples, adjusting the binder fraction may include decreasing the binder fraction to reach the target binder fraction by blending high carbon fraction biochar with the low carbon fraction biochar. High carbon fraction biochar may be biochar having greater than 70% carbon by mass. In this way, the low carbon fraction biochar included in the biochar concrete may be one or more of low carbon fraction biochar used directly from pyrolysis, low carbon fraction biochar blended with ash products, high carbon fraction biochar blended with low carbon fraction biochar, and high carbon fraction biochar blended with ash product. The high carbon fraction biochar blended with ash may result in a blended low carbon fraction biochar having less than 70% carbon by mass.

The binder fraction of the biochar may be adjusted based on a target biochar dose in a concrete formulation including the biochar. For example, a target binder fraction of the biochar may increase with an increasing target biochar dosage for the concrete formulation. Likewise, a target binder fraction of the biochar may decrease with a decreasing target biochar dosage. Additionally or alternatively, adjusting binder fraction may include forming a test formulations at different target doses and binder fractions and testing their physical properties to determine a desired binder fraction and target dose. Physical properties may include, but are not limited to compressive strength and durability. In some examples, binder fraction and target may be iteratively tested and adjusted until desired binder fraction and target dose are reached. Adjusting the biochar in this way may result in a biochar ingredient for a concrete formulation that results in controlled and verified results. In contrast, adjusting SCM content by adding additional biochar and/or ash material at the formulation stage may result in uncertainties in the properties of the mixture.

At 106, method 100 includes calculating the biochar concrete formulation based on the biochar binder fraction or adjusted biochar binder fraction, if adjusted at step 104. By using the biochar binder fraction in the calculation, an amount of the biochar acting as a SCM is treated as SCM in the calculation and an amount of biochar acting as an aggregate is treated as aggregate in the calculation and each fraction is therefore counted separately in the calculation, leading to a stronger concrete than if the same biochar is accounted for as all SCM or all aggregate. A method for calculating the concrete formulation, including mass and volumes of cement, SCM, fine aggregate, and water content is discussed in further detail below with respect to FIG. 6. At 108, method 100 includes forming the biochar concrete using the calculated biochar concrete formulation from step 106. Method 100 ends.

Turning now to FIG. 2, a flowchart of a method 200 for determining a binder fraction of the biochar is shown. As discussed above the binder fraction may be used to quantify an amount of SCM material comprising the biochar for use in calculating a biochar concrete formulation.

At 202, method 200 includes physically analyzing an atomic structure of the biochar to quantify a ratio of crystalline content to amorphous content of the biochar. In one example, biochar may be physically analyzed using a scanning electron microscope (SEM). Turning briefly to FIG. 3A, an SEM image 300 of a rice husk derived biochar and an SEM image 320 of a municipal waste derived biochar are shown. Physical characteristics such as grain size and shape may be determined through SEM analysis. Backscattered electrons detected in the SEM may be used to determine crystallinity of the biochar.

Additionally or alternatively, biochar may be physically analyzed using X-ray diffraction. Turning briefly to FIG. 4, an XRD spectrum 400 of the rice husk derived biochar and an XRD spectrum 450 of the municipal biosolid derived biochar are shown. Peak width in an XRD spectrum is indicative of degree of crystallinity. XRD spectrum 400 shows only a broad low angle peak 402, whereas XRD spectrum 450 shows some sharp peaks 452 superimposed on the broad low angle peak 454. In this way, XRD may show that the rice husk derived biochar is less crystalline than the biochar derived from municipal solids. In some examples, quantification of peak widths (e.g., average full width at half max) may be used to quantify crystallinity of the biochar.

Additionally or alternatively, Fourier transform infrared (FTIR) spectroscopy may be used to physically analyze the biochar and quantify a ratio of crystalline content to amorphous content of the biochar.

Returning now to FIG. 2, at 204, method 200 includes measuring a chemical composition of the biochar to quantify ash and organic material. Measuring the chemical composition may include analyzing the biochar using analytical instruments capable of both qualitative and quantitative chemical analysis. For example, measuring the chemical composition may include measuring using one or more of energy dispersive X-ray spectroscopy (EDS), X-ray fluorescence (XRF) spectroscopy, and atomic absorption spectroscopy (AAS). Additionally or alternatively, loss on ignition (LOI) may be used to quantify an organic (e.g., carbon and hydrogen) content of the biochar.

Turning briefly to FIG. 3B, greyscale EDS composition maps measured from the SEM images of FIG. 3A are shown. A first EDS map 340 corresponds to SEM image 300 of the rice husk derived biochar. A second EDS map 360 corresponds to SEM image 320 of the municipal waste derived biochar. A key 380 is provided for corresponding elements shades of grey shown in first EDS map 340 and second EDS map 360. First EDS map 340, shows a carbon and silicon content evenly dispersed throughout the material in the rice husk derived biochar. Second EDS map 360 shows different elemental content such as sulfur, calcium and phosphorous are in localized areas of the municipal waste derived biochar. Spatial composition data derived and quantified by EDS based on a line scan showing relative composition as a function of distance across the SEM image. Alternatively, intensities may be integrated across the image to provide average compositional information.

As another example, compositional information may be determined by XRF. Table 1 below shows chemical composition of the rice husk derived biochar and the municipal biosolid derived biochar as determined by XRF spectroscopy and LOI. Ash is calculated as the total of the mineral components measured by XRF. The biochar is assumed to be comprised of an organic fraction and an ash fraction. In this way, measuring chemical composition can be used to determine a mass percent of ash and a mass percent of organic material forming the biochar. A total of LOI content plus ash content is expected to be approximately (e.g., +/−3%) 100%.

TABLE 1
Composition of biochars as determined by XRF and LOI.

| | Rice Husk Biochar | Municipal Biosolid Biochar |
|---|---|---|
| Component | Composition (mass %) | Composition (mass %) |
| Na₂O_{eq} | 0.07 | 1.5 |
| MgO | 0.19 | 2.3 |
| Al₂O₃ | 0.21 | 7.8 |
| SiO₂ | 41.14 | 22.5 |
| P₂O₅ | 0.37 | 9.1 |
| SO₃ | 0 | 0 |
| CaO | 0.27 | 9.1 |
| Fe₂O₃ | 0.06 | 9.3 |
| LOI | 57 | 36.8 |
| Ash | 42.31 | 61.6 |
| Total | 99.31 | 98.4 |

As shown in Table 1, despite both being biochars derived by pyrolysis of organic waste materials, the chemical composition varies significantly depending on the source of the waste stream. The rice husk derived biochar is higher in organic material and lower in ash content whereas the municipal biosolid derived biochar is higher in ash content and lower in organic material. Both biochars may have carbon content less than 70% and are therefore examples of low carbon fraction biochar.

At 206, method 200 optionally incudes measuring a pozzolanic reactivity test (PRT) of the biochar to determine a degree of reactivity (DoR) of the biochar. The PRT score may quantify the pozzolanic activity of a material and may be used in combination with theoretical predictions determine the DoR. The PRT may subject the biochar to pozzolanic reactions and measure the heat generated.

Turning briefly to FIG. 5, a graph 500 plotting heat release as a function of calcium hydroxide (CH) consumed is shown. A first plot 502 corresponds to a theoretical prediction of heat release as a function of CH consumed if a SCM is comprised entirely of Al₂O₃ at different pozzolanic reactivities (e.g., degree of reactivity). A second plot 504 corresponds to a theoretical heat release as function of CH consumed at different pozzolanic activities if a SCM is comprised entirely of SiO₂. A first experimental data point 506 corresponds to a measured pozzolanic activity of the rice husk derived biochar. Placement of first experimental data point 506 on graph 500 corresponds to degree of reactivity of 25%. A second experimental data point 508 corresponds to measured pozzolanic activity of the municipal biosolids derived biochar. Placement of second experimental data point 508 on graph 500 corresponds to a degree of reactivity of 44% for the rice husk derived biochar.

Returning to FIG. 2, at 208, method 200 includes converting one or more of the crystalline to amorphous content ratio, chemical composition and DoR to binder fraction range. In one example, a maximum of the binder fraction range may be determined from the chemical composition. In further examples, a minimum of the binder fraction range may be determined from the DoR. In alternate examples, a minimum of the binder fraction may be determined from the crystalline to amorphous content ratio.

At 210, method 100 includes testing biochar concrete formulations within the binder fraction range to determine an optimal binder fraction. Testing may include forming biochar concrete based on calculating a formulation as described below with respect to FIG. 6 and physically testing the formed biochar concrete. Physical testing may test for characteristics related to performance of concrete, such as but not limited to strength and durability. The binder fraction resulting in the best performing concrete may be determined to be the optimal binder fraction. In this way, structural and physical properties of the resulting biochar concrete may be related to a structure and composition of the biochar included in the concrete. Method 200 ends.

Determining the binder fraction using method 200 recognizes the reactive potential of using high ash content biochar. The pozzolanic reaction of the biochar may take weeks or months to occur and is secondary to a primary hydration reaction in concrete taking place on a scale of hours and days. The pozzolanic reaction may include reactions between amorphous forms of silica oxide and alumina oxide with excess calcium hydroxide which is a byproduct of the primary hydration reaction. Using biochars which are high in mineral content and also test to have high levels of pozzolanic reactivity may be beneficial to resulting concrete materials when the concrete is formulated appropriately.

Turning now to FIG. 6, a flow chart of a method 600 for determining a biochar concrete formulation including an amount of water, fine aggregate, and non-biochar cementitious material. Method 600 may use the amount of SCM in the biochar determined using method 200 in order to calculate a binder fraction as described above with respect to equation 1 and FIG. 1.

At 602, method 600 includes calculating air and water volumes for the concrete formulation. The water volume may be calculated using equation 2 shown below and the air volume may be calculated using equation 3.

$$Vol {.}_{Water} = \frac{w / c * Tot . Cem . Mass ( lb . )}{{Mass}_{1 {ft}^{3} water} ( lb . )} \qquad ( 2 )$$

$$Vol {.}_{Air} = 27 {ft}^{3} * Air Content ( \% ) \qquad ( 3 )$$

Volume of water may depend on a desired water/cement (w/c) ratio for the biochar concrete and the total mass of cement desired. The w/c ratio may be determined based on a desired strength of the biochar concrete. As one example the w/c ratio may be in range of 0.3 to 0.6. Volume of air may depend on a desired air content of the biochar concrete. For example, air content may be in a range of 1% to 7%.

At 604, method 600 includes calculating a biochar SCM mass percent based on the binder fraction of the biochar. The Biochar SCM mass percent may be determined using equation 4 shown below.

$$Biochar SCM Mass Percent ( \% ) = Target Biochar Dose ( \% ) * Binder Fraction ( \% ) \qquad ( 4 )$$

Binder fraction of a biochar may be determined using method 200 and equation 1 as described above. As shown by equation 4, the biochar SCM mass percent may be directly proportional to the target biochar dose and the binder fraction. The biochar SCM mass percent of the biochar concrete formulation may be adjusted by adjusting either the target biochar dose and/or the binder fraction. In one example, a target biochar dose may be less than or equal to 40% and a binder fraction may be in a range of 10% up to 70%.

At 606, method 600 includes calculating non-biochar cementitious material (CM) mass, biochar SCM mass, and total volumes of the non-biochar CM, biochar SCM, and total cement. Biochar SCM mass may be calculated using equation 5 and non-biochar CM mass may be calculated using equation 6 shown below. Herein Portland limestone cement (PLC) is used as an example of non-biochar CM.

$$Biochar SCM Mass ( lb . ) = Biochar SCM Mass Percent ( \% ) * Tot . Cem . Mass ( lb . ) \qquad ( 5 )$$

$$P L C Mass ( lb . ) = Tot . Cem . Mass ( lb . ) - Biochar SCM Mass ( lb . ) \qquad ( 6 )$$

Biochar SCM mass may be calculated based on the total cement mass determined at step 602 and the Biochar SCM mass percent determined at step 604. Once the biochar SCM mass is determined, the remainder of the total cement mass is made up with Portland-limestone cement (PLC). In this way, only the portion of the biochar that acts as SCM is accounted for as SCM in the total cement. For this reason, the amount of water determined at 602 based on the total cement is accurately based on a total mass of cementitious materials, thereby resulting in a biochar concrete with improved physical strength. Accounting for the biochar completely as non-SCM may result in adding less water than is actually demanded and accounting for biochar completely as SCM may result in adding more water than is actually demanded. Too much or too little water may negatively impact strength of the biochar concrete. Volumes of biochar and PLC may then be calculated using the specific gravity of each. The total cement volume may be equal to the combined volumes of the PLC and biochar.

At 608, method 600 includes calculating a total aggregate volume and initial sand mass and volume. Total aggregate volume may be calculated using equation 7 shown below.

$$Tot . Agg . Vol . ( {ft}^{3} ) = 27 {ft}^{3} - Vol {.}_{Water} ( {ft}^{3} ) - Vol {.}_{Air} ( {ft}^{3} ) - Tot . Cem . Vol . ( {ft}^{3} ) \qquad ( 7 )$$

Total aggregate volume may depend on the volume of water and air calculated at step 602 as well as the total cement volume determined at step 606. As shown in equation 7, total aggregate volume may be the volume left over after the volumes of water, air, and cement are accounted for. Initial sand mass may then be calculated using equation 8 shown below.

$$Initial Sand Mass ( lb . ) = Spec . Grav . Sand * Mass 1 {ft}^{3} water ( lb . ) * Tot . Agg . Vol . ( {ft}^{3} ) * Sand Fraction ( \% ) \qquad ( 8 )$$

The sand fraction may be a percent of the aggregate to be comprised of fine aggregate. A remainder of the aggregate may be comprised of coarse aggregate. As one example a sand fraction may be in a range of 30% to 60%. A sand specific gravity may be used to convert the initial sand volume to an initial sand mass.

At 610, method 600 includes calculating a final sand volume percent based on a volume of non-SCM biochar aggregate. The mass of non-SCM biochar in the biochar concrete formulation may be determined by equation 9 shown below.

$$Mass Biochar Non . SCM ( lb . ) = Biochar SCM Mass ( lb . ) * ( 100 \% - Cem . Fraction ( \% ) ) \qquad ( 9 )$$

Mass of biochar non. SCM may be determined from the biochar mass times the remaining percent after the binder fraction is accounted for. Specific gravity of the biochar may then be used to convert the mass of non. SCM biochar to a volume of non. SCM biochar. The initial volume of sand calculated at step 608 may then be adjusted based on the volume of non-SCM biochar as shown in equation 10 below.

$$Final Vol . Sand ( {ft}^{3} ) = Initial Vol . Sand ( {ft}^{3} ) - ( \frac{Vol . Biochar Non . SCM ( {ft}^{3} )}{Tot . Agg . Vol . ( {ft}^{3} )} * 100 ) \qquad ( 10 )$$

In this way, the volume of biochar added that is not cementitious is accounted for in the fine aggregates of the formulation by adjusting the volume of sand added. Method 600 ends.

Turning now to FIG. 7, an example of a biochar concrete 700 formed by methods 100, 200, and 600 is shown. The biochar concrete may include a larger mass percent of biochar while maintain desired properties, such as strength and durability. The larger mass may be larger than what is included in a biochar concere formulation determined by conventional means by accounting for biochar as a single component.

The technical effect of methods 100, 200, and 600 is to produce a biochar concrete which includes high mineral content biochar without compromising strength of the biochar. The enable the use of high mineral content biochar by recognizing the importance of pozzolanic reactions and accounting for the ability of the biochar to react as an SCM in the biochar concrete formulation. In this way, a biochar concrete formulation of increased strength wherein water is not under or over accounted for is obtained. Further, the formulation takes effective pH of the biochar into account, leading to improved biochar concrete physical properties.

The disclosure also provides support for a biochar concrete, comprising: a low carbon fraction biochar, wherein the low carbon fraction biochar is less than 70% carbon by mass, non-biochar cementitious material, coarse aggregate, fine aggregate, and water, wherein a mass of the low carbon fraction biochar, a mass of the non-biochar cementitious material, a mass of the coarse aggregate, a mass of the fine aggregate, and a mass of the water depend on a binder fraction of the low carbon fraction biochar. In a first example of the system, the low carbon fraction biochar is manufactured from one or more of wood based biomass, agriculturally sourced biomass, aquatic plant sourced biomass, municipal waste biomass, animal waste, food waste source biomass, and yard waste biomass. In a second example of the system, optionally including the first example, biochar is ground biochar ground by one or more of vortex milling, hammer milling, roller milling, and disk milling. In a third example of the system, optionally including one or both of the first and second examples, the low carbon fraction biochar includes one or more of biogenically sourced ash products, combustion ash products, and chemical admixtures. In a fourth example of the system, optionally including one or more or each of the first through third examples, the biogenically sourced ash products and/or combustion ash products are ground ash products ground by one or more of vortex milling, hammer milling, roller milling, or disk milling. In a fifth example of the system, optionally including one or more or each of the first through fourth examples, the low carbon fraction biochar is a blend of high carbon fraction biochar and ash products, wherein the high carbon fraction biochar is greater than 70% carbon by mass. In a sixth example of the system, optionally including one or more or each of the first through fifth examples, the low carbon fraction biochar is a blend of low carbon fraction biochar and ash products. In a seventh example of the system, optionally including one or more or each of the first through sixth examples, an effective pH of the low carbon fraction biochar is greater than 7.

The disclosure also provides support for a method for forming biochar concrete, comprising: determining a binder fraction of a biochar, wherein the binder fraction is based on a fraction of supplementary cementitious material in the biochar, calculating a biochar concrete formulation including a volume of water and a mass of non-biochar cementitious material based on a target biochar dose and the binder fraction, and forming the biochar concrete using the biochar and the calculated biochar concrete formulation. In a first example of the method, the biochar is low carbon fraction biochar comprised of less than 70% carbon by mass. In a second example of the method, optionally including the first example, a supplementary cementitious material biochar mass is a product of the target biochar dose and the binder fraction. In a third example of the method, optionally including one or both of the first and second examples, the mass of non-biochar cementitious material is a remainder of a difference between a total cement mass and the supplementary cementitious material biochar mass. In a fourth example of the method, optionally including one or more or each of the first through third examples, the method further comprises: increasing the binder fraction of the biochar to a target binder fraction by adding ash to the biochar before calculating the biochar concrete formulation. In a fifth example of the method, optionally including one or more or each of the first through fourth examples, the method further comprises: determining a final sand volume based on a non-supplementary cementitious material fraction of the biochar. In a sixth example of the method, optionally including one or more or each of the first through fifth examples, the method further comprises: adjusting a composition of the biochar to reach a target binder fraction. In a seventh example of the method, optionally including one or more or each of the first through sixth examples, the method further comprises: measuring an effective pH of the biochar.

The disclosure also provides support for a method for forming biochar concrete, comprising: determining a binder fraction range of a biochar based on quantifying one or more of an atomic structure, a chemical composition, and a degree of reactivity of the biochar and determining an optimal binder fraction from the binder fraction range, calculating a biochar concrete formulation by treating the determined optimal binder fraction of the biochar as supplementary cementitious material and a remainder of the biochar as aggregate, and and forming the biochar concrete using the calculated biochar concrete formulation. In a first example of the method, determining the optimal binder fraction includes testing biochar concrete formulations within the binder fraction range. In a second example of the method, optionally including the first example, quantifying the atomic structure includes quantifying a ratio of crystalline content to amorphous content of the biochar. In a third example of the method, optionally including one or both of the first and second examples, the atomic structure is quantified using one or more of scanning electron microscopy, X-ray diffraction, and Fourier transform infrared spectroscopy. In a fourth example of the method, optionally including one or more or each of the first through third examples, quantifying the chemical composition includes quantifying mass percent of ash and mass percent of organic material of the biochar. In a fifth example of the method, optionally including one or more or each of the first through fourth examples, the chemical composition is quantified by one or more of energy dispersive X-ray spectroscopy, X-ray fluorescence spectroscopy, loss on ignition, and atomic absorption spectroscopy. In a sixth example of the method, optionally including one or more or each of the first through fifth examples, the degree of reactivity of the biochar is quantified by a Pozzolanic Reactivity Test. In a seventh example of the method, optionally including one or more or each of the first through sixth examples, the method further comprises: measuring an effective pH of the biochar by soaking the biochar in water and measuring a resulting pH of the water.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A biochar concrete, comprising:
a low carbon fraction biochar, wherein the low carbon fraction biochar is less than 70% carbon by mass;
non-biochar cementitious material;
coarse aggregate;
fine aggregate; and
water, wherein a mass of the low carbon fraction biochar, a mass of the non-biochar cementitious material, a mass of the coarse aggregate, a mass of the fine aggregate, and a mass of the water depend on a binder fraction of the low carbon fraction biochar.

2. The biochar concrete of claim 1, wherein the low carbon fraction biochar is manufactured from one or more of wood based biomass, agriculturally sourced biomass, aquatic plant sourced biomass, municipal waste biomass, animal waste, food waste source biomass, and yard waste biomass.

3. The biochar concrete of claim 1, wherein the low carbon fraction biochar includes one or more of biogenically sourced ash products, combustion ash products, and chemical admixtures.

4. The biochar concrete of claim 3, wherein the low carbon fraction biochar is ground biochar ground by one or more of vortex milling, hammer milling, roller milling, and disk milling, and wherein the biogenically sourced ash products and/or combustion ash products are ground ash products ground by one or more of vortex milling, hammer milling, roller milling, and disk milling.

5. The biochar concrete of claim 1, wherein the low carbon fraction biochar is a blend of high carbon fraction biochar and ash products, wherein the high carbon fraction biochar is greater than 70% carbon by mass.

6. The biochar concrete of claim 1, wherein the low carbon fraction biochar is a blend of low carbon fraction biochar and ash products.

7. The biochar concrete of claim 1, wherein an effective pH of the low carbon fraction biochar is greater than 7.

8. A method for forming biochar concrete, comprising:
determining a binder fraction of a biochar, wherein the binder fraction is based on a fraction of supplementary cementitious material in the biochar;
calculating a biochar concrete formulation including a volume of water and a mass of non-biochar cementitious material based on a target biochar dose and the binder fraction; and
forming the biochar concrete using the biochar and the calculated biochar concrete formulation.

9. The method of claim 8, wherein the biochar is low carbon fraction biochar comprised of less than 70% carbon by mass.

10. The method of claim 8, wherein a supplementary cementitious material biochar mass is a product of the target biochar dose and the binder fraction, and wherein the mass of non-biochar cementitious material is a remainder of a difference between a total cement mass and the supplementary cementitious material biochar mass.

11. The method of claim 8, further comprising determining a final sand volume based on a non-supplementary cementitious material fraction of the biochar.

12. The method of claim 8, further comprising adjusting a composition of the biochar to reach a target binder fraction, and wherein adjusting includes increasing the binder fraction of the biochar to the target binder fraction by adding ash to the biochar before calculating the biochar concrete formulation.

13. The method of claim 8, further comprising measuring an effective pH of the biochar.

14. A method for forming biochar concrete, comprising:
determining a binder fraction range of a biochar based on quantifying one or more of an atomic structure, a chemical composition, and a degree of reactivity of the biochar and determining an optimal binder fraction from the binder fraction range;
calculating a biochar concrete formulation by treating the determined optimal binder fraction of the biochar as supplementary cementitious material and a remainder of the biochar as aggregate; and
forming the biochar concrete using the calculated biochar concrete formulation.

15. The method of claim 14, wherein determining the optimal binder fraction includes testing biochar concrete formulations within the binder fraction range.

16. The method of claim 14, wherein quantifying the atomic structure includes using one or more of scanning electron microscopy, X-ray diffraction, and Fourier transform infrared spectroscopy to quantify a ratio of crystalline content to amorphous content of the biochar.

17. The method of claim 14, wherein quantifying the chemical composition includes quantifying mass percent of ash and mass percent of organic material of the biochar.

18. The method of claim 14, wherein the chemical composition is quantified by one or more of energy dispersive X-ray spectroscopy, X-ray fluorescence spectroscopy, loss on ignition, and atomic absorption spectroscopy.

19. The method of claim 14, wherein the degree of reactivity of the biochar is quantified by a Pozzolanic Reactivity Test.

20. The method of claim 14, further comprising measuring an effective pH of the biochar by soaking the biochar in water and measuring a resulting pH of the water.
